(19) United States
(12) Patent Application Publication
(10) Pub. No.: US 2016/0117776 A1
(43) Pub. Date: Apr. 28, 2016

(54) METHOD AND SYSTEM FOR PROVIDING ACCURATE ESTIMATES

(71) Applicant: SWYFFT, LLC, PARK CITY, UT (US)

(72) Inventor: Sean MAHER, Park City, UT (US)

(21) Appl. No.: 14/523,011

(22) Filed: Oct. 24, 2014

(51) Int. Cl. G06Q 40/08; G06Q 50/16

(52) U.S. Cl. CPC G06Q 40/08; G06Q 50/16

(57) ABSTRACT

A method is provided. The method includes receiving an address of a property to be insured; accessing an external attribute server and using only the address, retrieving attributes of the property to be insured from the external attribute server; calculating a premium estimate of insurance for the property to be insured based on the attributes of the property; generating a final insurance premium estimate by multiplying the calculated estimate by a multiplier; and transmitting the final insurance premium estimate to a device from which the address of the property to be insured was received.

### BACKGROUND

1. Field

Apparatuses, systems, and methods consistent with the present disclosure relate generally to technology for improving the accuracy of property insurance premium estimates and technology for more expediently providing the premium estimates to a user.

2. Description of the Related Art

In the consumer insurance industry, previously the customer would have to meet with an insurance agent to discuss their situation and provide information on a real estate property to be insured. The agent would then consider the information, and prepare and mail a premium estimate or quote for insuring the property. If the customer had questions or wanted to discuss the premium estimate, the customer could then call the agent. This process required a customer to take time to set up an appointment, and then additional time for the agent to prepare the premium estimate, for the customer to receive the premium estimate from the agent and discuss the premium estimate, etc. Using this process, it would take from several days to a week or more to provide the customer with the premium estimate. In order to comparison shop, the customer would have to meet with several agents, and the process would then consume even more time.

More recently, insurers have been providing web-based systems as a first point-of-contact with customers. The web-based system provides a graphical user interface (GUI), typically as a web page accessible by the user through a web browser over the Internet. The GUI allows the user to enter various information related the user's situation and information related to a property to be insured, and receive a premium estimate for insuring the property in a day, or in some cases, even a matter of minutes, rather than days or weeks. Thus, a major advantage and a key selling point for insurance companies that offer such web-based systems is the ease of use for the user, since the user does not need to meet with the agent, and the speed of providing the premium estimate, since the relevant information is provided by the user in digital form, which facilitates the work of preparing the premium estimate.

However, there are several disadvantages with the related art web-based systems. Often the user either does not have the information requested, or does not have correct information related to the property. In the previous method, the agent could during the meeting ask the customer for the relevant information, and help the customer to understand what information is needed and the best sources for obtaining the information, and then once the information was received, the agent could verify the information before proceeding to prepare the premium estimate. However, in the web-based system this is not possible. Thus, even using a related art web-based system, there is a disadvantage in that the quote is only as accurate as the type and validity of the information provided by the user.

Another related disadvantage is in the amount of information that the related art web-based systems require from the user. A typical web-based system will ask the user on the order of sixty (60) different questions about the property to be insured and about the user's situation. Thus, the user is still required to answer a large number of questions and thus to provide a large amount of information, often with little guidance. This takes a great amount of the user's time, both for the user to marshal all the information and also for the user to simply enter the information into the web-based system. Moreover, each piece of information is subject to the validity disadvantages discussed above.

### SUMMARY

According to an aspect of one or more exemplary embodiments, there is provided a method comprising receiving an address of a property to be insured; accessing an external server and using only the address, retrieving a plurality of attributes of the property to be insured from the external server; calculating a premium estimate of insurance for the property to be insured based on the attributes of the property; generating a final insurance premium estimate by multiplying the calculated estimate by at least one multiplier; and displaying the final insurance premium estimate.

According to another aspect of one or more exemplary embodiments, there is provided a method comprising receiving an address of a property to be insured; accessing an external server and using only the address, retrieving a plurality of attributes of the property to be insured; calculating a base estimate of insurance for the property based on the attributes of the property; determining a fire factor multiple based on the received address; when the fire factor multiple is greater than or equal to a threshold value for a geographical region including the address, displaying a notification of a decline to insure the property; and when the fire factor multiple is less than the threshold value, generating a final estimate by multiplying the base estimate by the fire factor multiple, and displaying the final estimate.

According to yet another aspect of one or more exemplary embodiments, there is provided a method comprising receiving an address of a property to be insured; accessing a first external server and using only the address, retrieving a plurality of physical attributes of the property to be insured; accessing a second external server and using only the address, retrieving an assessed value for the property to be insured; determining an estimated replacement cost for the property based on the retrieved assessed value and the retrieved physical attributes of the property; calculating a base insurance premium estimate for the property based on the estimated replacement cost and a base rate; accessing a second external server and retrieving a plurality of fire data for properties within a geographic region including the address, from the second external server; determining a plurality of different areas within the geographic region, each area including the address and including a different number of housing units of the geographic region; calculating a fire rate for each area using the retrieved fire data; for each fire rate, calculating a rate difference between the fire rate and an average base fire rate for the geographic region, and selecting a fire rate having a largest rate difference as a fire factor multiple; when the selected fire factor multiple is greater than or equal to a threshold value for the geographical region, displaying a notification of a decline to provide a premium estimate to insure the property; and when the selected fire factor multiple is less than the threshold value, generating a final estimate by multiplying the base insurance premium estimate by the selected fire factor multiple, and displaying the final estimate.

### BRIEF DESCRIPTION OF THE DRAWINGS

The above and other aspects will be more apparent from a description of various exemplary embodiments as illustrated in the accompanying drawings in which:

FIGS. 1-4 are screen shots of a graphical user interface (GUI) of a web-based homeowner's insurance estimation method according to an exemplary embodiment;

FIG. 5 is a system for providing an insurance premium estimate according to an exemplary embodiment;

FIG. 6 is an example of a computer device according to an exemplary embodiment;

FIG. 7 is a flowchart showing a web-based homeowner's insurance estimation method according to an exemplary embodiment;

FIG. 8 is a flowchart showing a web-based homeowner's insurance premium estimate method according to another exemplary embodiment;

FIG. 9 is a flowchart showing an example of determining a fire multiple according to an exemplary embodiment;

FIGS. 10 and 11 are examples of areas within a geographic region according to an exemplary embodiment; and

FIG. 12 is a system for providing an insurance premium estimate according to another exemplary embodiment.

### DETAILED DESCRIPTION

Exemplary embodiments are described below in sufficient detail to enable those of ordinary skill in the art to embody and practice the present inventive concept. It will be understood that the present inventive concept may be embodied in many alternate forms and should not be construed as limited to the exemplary embodiments set forth herein.

It will be understood that, although the terms “first,” “second,” “A,” “B,” etc. may be used herein in reference to various elements, such elements should not be construed as limited by these terms. For example, a “first” element could be termed a “second” element, and a “second” element could be termed a “first” element, without departing from the scope of the present disclosure. Herein, the term “and/or” includes any and all combinations of one or more referents.

The terminology used herein to describe exemplary embodiments is not intended to limit the scope of the present invented concept. The articles “a,” “an,” and “the” are singular in that they have a single referent; however the use of the singular form in the present document should not preclude the presence of more than one referent. In other words, elements referred to in singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which the present inventive concept belongs. It will be further understood that terms in common usage should also be interpreted as is customary in the relevant art and not in an idealized or overly formal sense unless expressly so defined herein.

When it is possible to implement any embodiment in any other way, a function or an operation specified in a specific block may be performed differently from a flow specified in a flowchart. For example, two consecutive blocks may actually perform the function or the operation simultaneously, and the two blocks may perform the function or the operation conversely according to a related operation or function.

In a related art web-based system, the user typically progresses through multiple web-based screens, and must enter various data on each screen. For example, an initial screen asks for a zip code of a user's address, and then includes a button to “get a quote.” After the user presses the “get a quote” button, a second screen is displayed. The second screen asks the user to enter the details of the address of a property, including a street address, an apartment/unit number, a city, and a state. This screen may also ask for the user to enter a desired start date for the home owner's insurance coverage. The user must then click a “next” button to proceed.

After clicking the “next button,” a third screen is displayed. This screen asks for details of the policy, such as the user's first and last name, the user's date of birth, and email address. The user must then indicate whether the user has other types of insurance policies with the company, and whether the user wants to add a second policy holder. The third screen also asks the user to enter various details about the user's home insurance history. For example, the user must indicate whether the home is a new home purchase, whether the property is currently insured, and if the property is currently insured, the expiration date of the current home policy. The user must then enter the number of home insurance claims over the last five (5) years, and the number of home insurance cancellations due to non-payment in the last three (3) years. Several of the items on the third screen have clickable hyperlinks to provide more information about the item. For example, the term “home insurance cancellations” may be clicked on to display the definition of a cancellation for the user. At the end of the third screen, the user must click “next” and in doing so acknowledge that the user has read an information disclosure, and that the user authorizes the use of consumer reports/records.

The user then proceeds to a fourth screen in which additional details of the property must be entered by the user. The user must enter the year the home was built, the square footage of the home, the market value, the architectural style, the number of stories of the home, and whether the property is a single family home or a multiple family home. As with several items above, the user may click on the term “square footage” in order to get more information about what is needed in the square footage item, and the screen may provide drop down menus for the user to select data for several of the items, such as the architectural style. The fourth screen continues with more questions about the details of the interior of the property. The user must enter the number of full and half bathrooms, the material used in the kitchen counter tops, the year the wiring was installed or updated, the ceiling height, the number of rooms with vaulted ceilings, the number of rooms with crown molding, the material or materials used in the inside walls of the house—for example whether drywall, plaster, or sheetrock—and the floor type for each room of the house. As with the other screen, several of the items may be provided with clickable terms to show the user more information on how to enter the data, and other items may be provided as selectable from drop-down lists. Thus, while some assistance is provided, the user is largely left on his or her own to decide how to enter the data.

Upon clicking “next” on the fourth screen, a fifth screen is displayed to prompt the user to enter more details about the exterior of the property. The user must indicate whether the property is on a slope, the type of exterior siding used, the roof shape, the roofing material used, the year the roof was installed, the foundation type, and the garage type and size. The user must also indicate whether there is a swimming pool on the property, and whether there is a trampoline installed.

Each of the above data items is used in the premium estimate calculation. For example, different types of exterior siding create different potential perils, the shape of the roof may suggest how likely water damage from sitting snow may occur, and the age of the roof suggests how soon shingles may need to be replaced and/or how well the roof will weather a bad storm.

Once the user clicks “next” on the fifth screen, yet another screen is displayed. The sixth screen requires the user to answer questions about the heating and cooling and safety features of the house. For example, the user must indicate the primary heating type—whether central air, forced air, window unit, etc., whether there is central air conditioning, how many fireplaces are on the property, and the type of the fireplaces, and whether a wood or coal burning stove is used in the property. For the safety features, the user must indicate whether the property has a sprinkler system, whether there is an security alarm system and the type of the system, whether all doors and windows have deadbolts, the fire alarm type, and the smoke detector type. Lastly, on the sixth screen the user must enter whether there is a fire extinguisher on the premises. As above, the heating and cooling suggest potential sources of perils, and the safety features may indicate peril reduction measure that may be used to decrease the insurance premium estimate in some cases.

After clicking “next” on the sixth screen, a seventh screen asks the user for details about who occupies the property. For example, the user must enter how the property will be used—whether as a rental, owner occupied property, or as a secondary residence. The user must enter the number of household members, and whether the household members are immediate family members. The user must enter whether the user owns a dog, the breed of the dog, and whether the dogs have ever bit someone. The user must indicate whether any of the land has been leased to a third party, whether a trustee, estate or company is on the property, and whether business is conducted on the property.

After clicking “next” on the seventh screen, a home owners insurance premium estimate is finally displayed on the eighth screen. The premium estimate indicates the types and amounts of coverage for the dwelling and the user's personal property, and may allow the user to change some of the amounts of coverage and recalculate the premium estimate based on the changed amounts of coverage. For example, the user may request increased protection for the dwelling beyond the indicated amount in the premium estimate. The user may also select a level of coverage for personal possessions. The user may indicate any special coverages desired such as earthquake or flood insurance, may change the deductibles, and may select different levels of liability coverage.

Finally, after entering eight screens of data and clicking on a “continue” button, a ninth page is displayed to the user for the user to enter payment information and complete the process of ordering home owner's insurance.

As illustrated above, for a typical related art web-based insurance system, the user must marshal many different types of information, much of which the user may not have much knowledge. While some help is provided by displaying terms that may be clicked for definitions and more information, the user is largely left to determine which information to enter on their own.

There are two disadvantages with the above related art web-based systems. First, the data provided by the user is not always accurate. For example, many people do not know the exact square footage of the house, which is used for calculating replacement cost. Second, requiring users to enter so much data is very time consuming compared to other online buying experiences (e.g., buying a book online using a 1-click method, or shopping online for clothing, etc.), and thus creates a major barrier to acquiring and keeping customers.

The present inventors have developed an improved web-based system that can provide a user with a homeowner's insurance premium estimate while only requiring the user to enter the address of the property to be insured. Thus, the user is provided with a much faster experience from initial screen to estimate. Moreover, since the user must only enter one data point—their own address—which every user knows by heart, accuracy of the data is ensured.

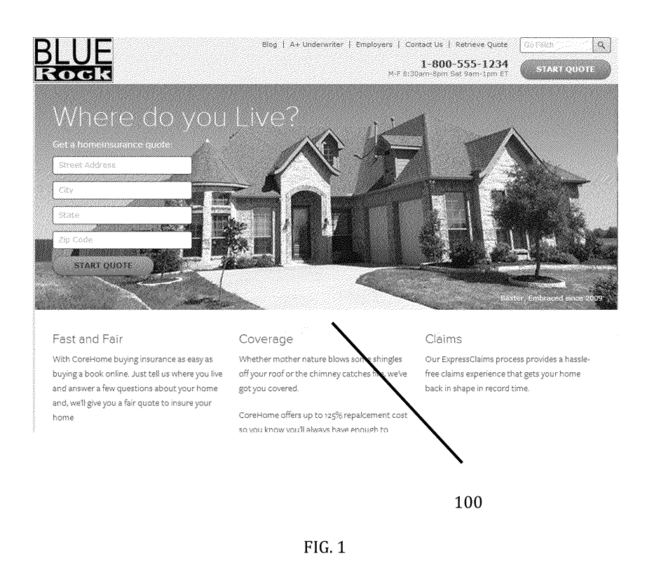

FIG. 1 shows a screen of a graphical user interface (GUI) for entering data according to an exemplary embodiment. As shown in FIG. 1, an initial screen 100 requests the user to enter a property address of a property to be insured. The user is prompted to enter the street address, city, state and zip code of the property, and then press a “start quote” button.

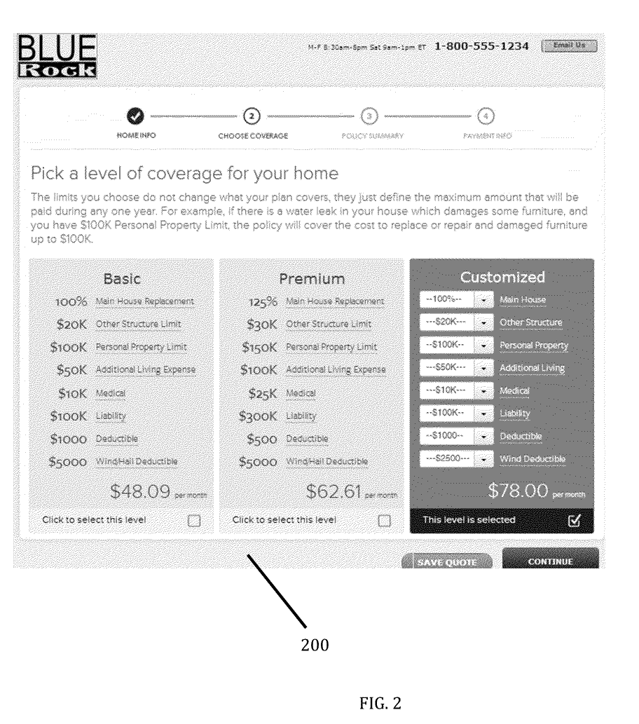

FIG. 2 shows a coverage choice screen according to an exemplary embodiment.

Immediately after the user clicks “start quote” on the initial screen 100, a coverage choice screen 200 is displayed. The coverage choice screen 200 displays a basic coverage box, a premium coverage box, and a customized coverage box. The basic coverage box includes various basic amounts of coverage. For example, the basic coverage in FIG. 2 shows 100% main house replacement, $20K other structure limit, $100K personal property limit, $50K additional living expense, $10K medical expense, $100K liability, a $1000 deductible, and a $5000 wind hail deductible. The premium coverage box includes coverage in premium amounts. For example, the premium coverage in FIG. 2 shows 125% main house replacement, $30K other structure limit, $150K personal property limit, $100K additional living expense, $25K medical expense, $300K liability, a $500 deductible, and a $5000 wind hail deductible. If the user finds either the basic or premium coverage acceptable, the user may check a box below the basic coverage box, or a box below the premium coverage box, and click “continue.” The customized coverage box allows the user to select customized amounts for each coverage, and for the deductibles. FIG. 2 shows the amounts provided as drop down menus. However, this is only an example and other methods may be used to allow the user to enter the amounts. If the user selects customized amounts, the user may check a box below the customized coverage box, and then click “continue.”

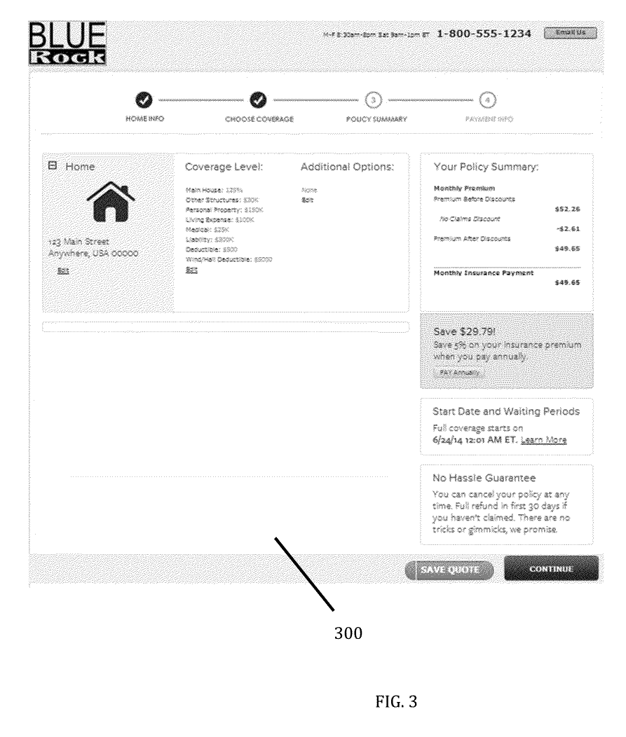

FIG. 3 is an example of a summary policy screen according to an exemplary embodiment. When the user clicks “continue” on the coverage choice screen 200, a policy summary screen 300 is displayed. The user may then review the coverage amounts and other details and click “continue.”

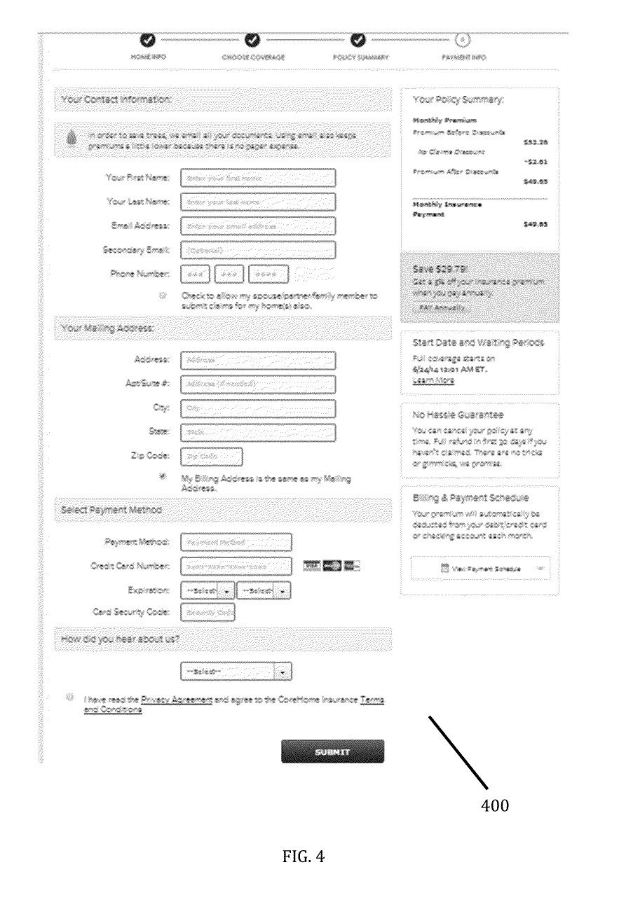

FIG. 4 is an example of a payment screen according to an exemplary embodiment. As shown in FIG. 4, the payment screen 400 prompts the user to enter payment details, and click “submit” to complete the home owner's insurance buying process.

According to the above-described exemplary embodiment, the user is only required to enter the address of the property to be insured in order to receive a premium estimate of coverage. After receiving the premium estimate of coverage, the user selects coverage levels and enters the user's payment information in order to complete the process. The address and payment information are both readily known by the user, and the coverage levels are selected based on the user's preference. Therefore, the user is not required to marshal a complex and extensive set of data, which decreases the time for the user to receive a premium estimate, and also since the user readily knows the information to be entered, the accuracy of the user-entered data is not an issue, as compared with the related art web-based system.

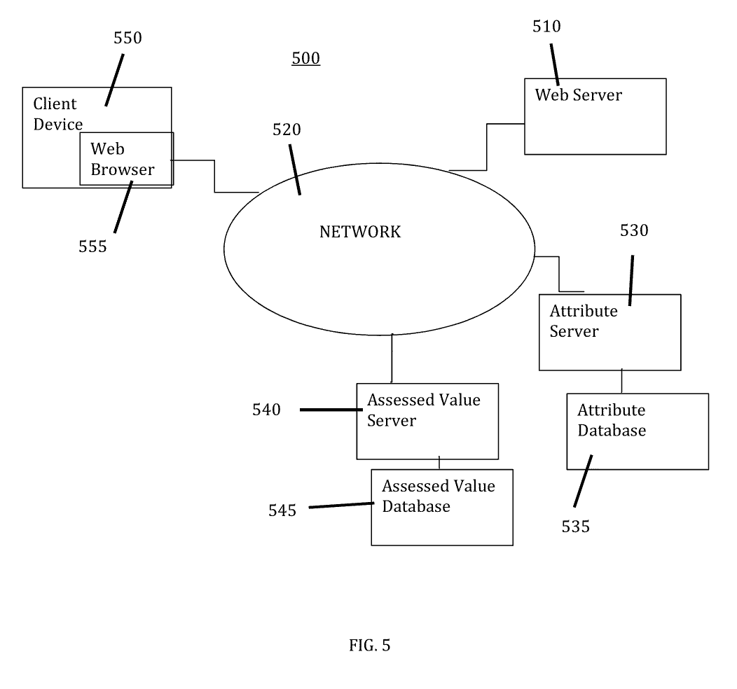

FIG. 5 is a block diagram of a computer network system on which an exemplary embodiment may be provided. As shown in FIG. 5, a computer network system 500 includes a web server 510, an attribute server 530, an assessed value server 540, and a client device 550. The web server 510, the attribute server 530, the assessed value server 540 and the client device 550 are communicatively coupled to a network 520 in order to communicate with each other.

The web server 310 runs a web-server application. Similarly, the client device 550 runs a web browser application 555. Thus, the client device 550 may use a universal resource locator (URL) of the web server 510 in order to communicate with the web server 510.

The attribute server 530 is communicatively coupled to an attribute database 535 that stores various attributes of a property in association with an address of the property. The attributes may include, for example, physical attributes of the property, attributes about the user, and/or financial attributes of the property. The attributes about the user may include, for example, age, income, length of residence, credit score, occupation, etc. The financial attributes about the property may include, for example, prior sale amounts and dates, estimated market value, mortgage value, mortgage term, mortgage interest rate, and other financial information associated with the property. The physical attributes may include, for example, the year the home on the property was built, the architectural style of the home, the number of stories of the home, the number of bathrooms of the home, the number of fireplaces in the home, the type of foundation, the type of parking, the age and type of heating and cooling system, a ceiling height for various rooms of the home, a number of rooms of the home that have crown molding, a number of rooms with vaulted ceilings, a type of inside wall for various rooms of the home, and flooring types used for different rooms of the home. The attribute database 535 may also store various peril information, such as for example a number of prior claims on the home, a number of fires the home has had, the number of home fires that have occurred in a geographic region in which the home is situated, etc. It will be understood that the above-described attributes are just examples, and additional information on the attributes of the property may also be included in the attribute database 535. Moreover, FIG. 5 shows a single attribute database 535. However, a plurality of attribute databases may also be provided. In such a situation, the different attribute databases may include different types of information. For example, one attribute database may have peril attributes of the property, while a different database may have interior attributes of the property, and yet another different database may have exterior attributes of the property, etc.

The assessed value server 540 is communicatively connected to an assessed value database 545 that stores a property tax assessed value of the property in association with an address of the property. The assessed value server 540 may be a server provided by a municipal organization that includes publicly available property tax assessed value information.

The client device 550 includes a web browser 555 for providing a graphical user interface (GUI) served up by the web server 510 through the network 520. That is, a user of the client device 550 may access a universal resource locator (URL) of the web server 510 in order to display a web page GUI for inputting data to the web server 510, and for receiving data and displaying data from the web server 510 on the client device 550. The client device 550 may be, for example, a personal computer (PC), a mobile phone, a smart phone, a tablet computer, or a personal data assistant, etc.

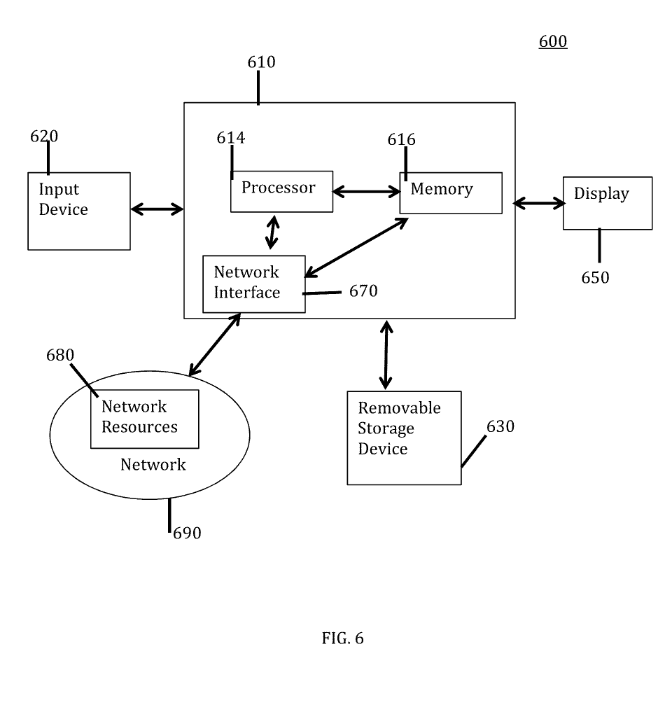

FIG. 6 is a block diagram of a computer device, according to an exemplary embodiment. FIG. 6 is a block diagram that illustrates a computer device 600 upon which an exemplary embodiment may be implemented. The computer device 600 represents a configuration of one or more of the client device 550, the web server 510, the attribute server 530, and the assessed value server 540. The computer device 600 includes a computer/server platform 610 including a processor 614 and memory 616 which operate to execute instructions. For example, the processor 614 may be a microcontroller or a microprocessor. Additionally, the computer platform 610 may receive input from a plurality of input devices 620, such as a keyboard, mouse, touch device or verbal command. The computer platform 610 may additionally be connected to a removable storage device 630, such as a portable hard drive, optical media (CD or DVD), disk media or any other tangible medium from which a computer can read executable code. The computer platform may further include a network interface (I/F) 670 for communicatively coupling to a network 690. The computer platform 610 may be communicatively coupled to network resources 680 which connect to the Internet or other components of a local network such as a LAN or WLAN. The local network may be a public or private network. The local network may be the network 520 of FIG. 5. The network resources 680 may provide instructions and data to the computer platform from a remote location on a network 690. The connections to the network resources 680 may be accomplished via wireless protocols, such as the 802.11 standards, BLUETOOTH® or cellular protocols, or via physical transmission media, such as cables or fiber optics. The network resources 680 may include storage devices for storing data and executable instructions at a location separate from the computer platform 610. The computer interacts with a display 650 to output a graphical user interface including data and other information to a user, as well as to request additional instructions and input from the user. The display 650 may therefore further act as an input device 620 for interacting with a user.

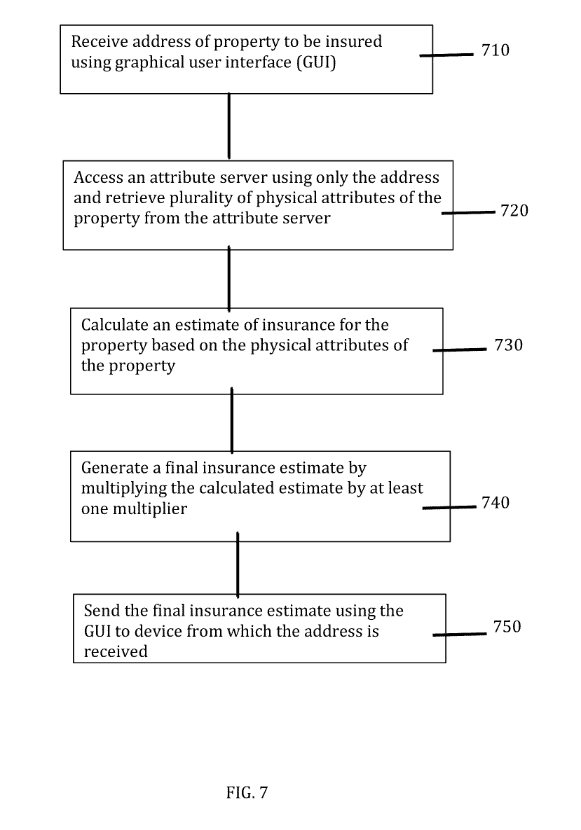

FIG. 7 is a flowchart showing a web-based homeowner's insurance estimation method according to an exemplary embodiment. The method of FIG. 7 will be explained in conjunction with FIGS. 1-6. The method of FIG. 7 is implemented by the web server 510.

The web server 510 receives an address of a property to be insured from a client device 550 using a graphical user interface (GUI) (710). The client device 550 under control of the processor 614 in conjunction with the memory 616 runs a web browser application. That is, a user of the client device 550 uses the input device 620 under control of the processor 614 to input a URL of the web server 510 to the web browser 555 of the client device 550 in order to access the web server 510. Upon accessing the URL, the web server 510 generates a web page to request entry of an address of a property to be insured, and sends the generated web page to the client device 550. The client device 550 receives the web page and displays an initial screen such as the initial screen shown in FIG. 1, and the user is requested to enter an address of a property to be insured. The user uses the input device 620 to enter address information for the property to be insured. The address information includes a street, city, state, and zip code of the property to be insured.

In some exemplary embodiments, the user may provide the address without entering the address into a GUI. For example, the client device 550 may be provided with a card reader. The user may thus swipe or scan a card, such as for example a driver's license, a passport, a credit card, an address card, etc. that is encoded with the user's address information, with the card reader. The card reader reads the address information encoded on the card and sends the address information to the server. The address information may be encoded in the card, using for example, a magnetic strip, a bar code, or a QR code. In the case of the magnetic strip, the user may swipe the card through the card reader to read the address information encoded in the magnetic strip. In the case of the bar code or QR code, the user may scan the card using a scanner to read the address information encoded in the bar code or QR code. The server uses the read address information to generate the premium estimate. In other exemplary embodiments, the user may take a photograph of a document that has printed thereon the user's address. For example, the client device 550 may be provided with a camera such as a camera of a smart phone in the case the client device 550 is realized as a smart phone, or with a web cam attached to the client device 550 in the case the client device 550 is realized as a PC. The user may use the camera or web cam, etc. to take the photograph of the document. The user may then use the input device 620 to command the client device 550 to perform optical character recognition (OCR) locally on the photograph in order to recognize the photographed address information. Alternatively, the user may command the client device 550 to send the photograph from the client device to the server, and the server may perform optical character recognition (OCR) on the photograph of the document to recognize the address. The recognized address is then used to prepare the premium estimate.

In some exemplary embodiments, no input from the user is used in order to receive a premium estimate. In this case, the user logs into another system where the user has previously provided their home address (e.g. a user logs into an online shopping account or an email account), and that other system provides the address. In this case, a single click of a “Get Quote” button can retrieve the estimated monthly premiums for a user's house.

In other exemplary embodiments, a user is provided with a code that that is linked to their address. The user then enters the code to receive an insurance premium estimate. For example, a user may be mailed a letter with a code comprising various alphanumeric digits and/or various symbols that the user enters into the web server 510. The web server 510 then links the code to an associated address and provides the user with a premium estimate. This further shortens the data input time required of the user. The code may be a visible code printed on the letter. Alternatively, the code may be an invisible code which may be read by an infrared scanner. Alternatively, the code may be provided as a bar code or QR code printed on the letter, which is scanned by the user using a camera or web cam.

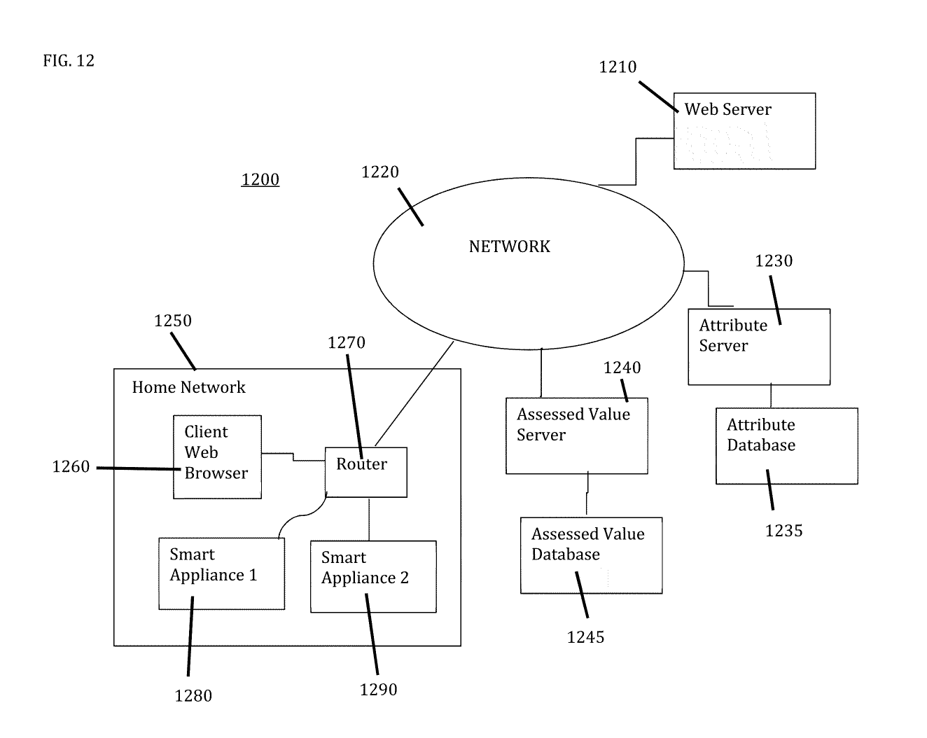

In still other exemplary embodiments, the address may be received from an address-aware smart home appliance. For example, an address-aware smart home appliance may know its own address either because the address-aware smart home appliance has been registered with a local fire department or other company, or because the address-aware smart home appliance has a GPS chip or IP mapping capability included therein. For example, a smart smoke detector may have the address of the property in which the smart smoke detector is installed stored therein, and may provide the stored address. A system for implementing these exemplary embodiments is described in more detail below with reference to FIG. 12.

In additional exemplary embodiments, there may be an address confirmation operation performed immediately after the address is provided (either by a user or a third party system). In the address confirmation operation, an address in standardized format is presented to the user alongside the address that the user entered and the user is asked to confirm that the standardized address is the user's property address.

Returning to FIG. 7, in operation 720, the web server 510 accesses the attribute server 530, and using only the address of the property to be insured, retrieves a plurality of attributes of the property from the attribute server 530. The attributes may include, for example, physical attributes of the property, attributes about the user, and/or financial attributes of the property. The physical attributes may include, for example, the year the home on the property was build, the architectural style of the home, the number of stories of the home, the number of bathrooms of the home, the number of fireplaces in the home, the type of foundation, the type of parking, the age and type of heating and cooling system, a ceiling height for various rooms of the home, a number of rooms of the home that have crown molding, a number of rooms with vaulted ceilings, a type of inside wall for various rooms of the home, flooring types used for different rooms of the home, etc. The attributes about the user may include, for example, age, income, length of residence, credit score, occupation, etc. of the user. The financial attributes about the property may include, for example, prior sale amounts and dates, estimated market value, mortgage value, mortgage term, mortgage interest rate, and other financial information associated with the property. The attribute server 530 accesses the attribute database 535 and uses the address to search through the database and provides the attributes associated with the address to the web server 510.

In operation 730, the web server 510 calculates a premium estimate of insurance for the property based on the retrieved attributes. For example, one of the attributes may be a property tax assessed value for the property that is retrieved from the assessed value server 540. A replacement cost is estimated using one or more of the following: property tax assessed value, property construction type, square footage of the property, prior sale amount, prior sale date, mortgage amount, mortgage date, mortgage term, estimated market value, renovation types, and/or renovation costs.

By contrast, in the related art, a replacement cost is typically assessed by asking a homeowner about many attributes of their house. For example, the following pieces of data are typical of those used by existing systems to estimate a replacement cost:

a. Year Built

b. Architectural Style

c. Square footage

d. Number of Stories

e. Number on Bathrooms

f. Number of fireplaces

g. Type of foundation

h. Type of parking

i. Age and Type of heating and cooling system

j. Ceiling Height

k. Number of rooms with crown molding

l. Number of rooms with vaulted ceilings

m. Construction

n. Inside Wall Type

o. Percentage of different floor types

An initial premium is determined by multiplying the replacement cost estimate by a Base Rate (e.g. $900 per $100,000 of replacement cost). Those skilled in the art will appreciate there are various ways of determining a Base Rate. One way is to use loss costs provided by the Insurance Services Office (ISO). Another is to use base rates from public Department of Insurance filings of other insurance companies.

In operation 740, the web server 510 multiplies the calculated estimate by at least one multiplier in order to generate a final estimate. For example, in some exemplary embodiments, the initial premium may be modified by a Limit of Insurance (LOI) factor that is a function of the replacement cost. This type of adjustment is known to those skilled in the art. Intuitively it captures the well-known effect that larger buildings incur smaller losses as a percentage of building value than smaller buildings. An example table of Limit of Insurance factors is shown in Table 1 below:

TABLE 1

| | Max | |
|---|---|---|
| Min Replacement | Replacement | LOI |
| Cost | Cost | Factor |
| $1 | $5,000 | 6 |
| $5,000 | $10,000 | 6 |
| $10,000 | $20,000 | 4 |
| $20,000 | $30,000 | 2.7 |
| $30,000 | $40,000 | 2.1 |
| $40,000 | $50,000 | 1.72 |
| $50,000 | $60,000 | 1.5 |
| $60,000 | $70,000 | 1.35 |
| $70,000 | $80,000 | 1.22 |
| $80,000 | $90,000 | 1.12 |
| $90,000 | $100,000 | 1.05 |
| $100,000 | $110,000 | 1 |
| $110,000 | $120,000 | 0.96 |
| $120,000 | $130,000 | 0.93 |
| $130,000 | $140,000 | 0.9 |
| $140,000 | $150,000 | 0.87 |
| $150,000 | $160,000 | 0.84 |
| $160,000 | $170,000 | 0.81 |
| $170,000 | $180,000 | 0.79 |
| $180,000 | $190,000 | 0.77 |
| $190,000 | $200,000 | 0.75 |
| $200,000 | $250,000 | 0.73 |
| $250,000 | $300,000 | 0.65 |
| $300,000 | $350,000 | 0.6 |
| $350,000 | $400,000 | 0.57 |
| $400,000 | $450,000 | 0.55 |
| $450,000 | $500,000 | 0.54 |
| $500,000 | $550,000 | 0.54 |
| $550,000 | $600,000 | 0.53 |
| $600,000 | $650,000 | 0.52 |
| $650,000 | $700,000 | 0.51 |
| $700,000 | $750,000 | 0.5 |
| $750,000 | $800,000 | 0.49 |
| $800,000 | $900,000 | 0.48 |
| $900,000 | $1,000,000 | 0.47 |
| $1,000,000 | $1,100,000 | 0.46 |
| $1,100,000 | $1,200,000 | 0.45 |
| $1,200,000 | $1,300,000 | 0.44 |
| $1,300,000 | $1,400,000 | 0.43 |
| $1,400,000 | $1,500,000 | 0.43 |
| $1,500,000 | $100,000,000 | 0.43 |

The premium may also be modified by a Previous Claims factor related to the number of claims that have been filed over the past 1-10 years. An example Previous Claims table is shown in Table 2 below:

TABLE 2

| Years | 0 | 1 | 2 | 3 | 4 |
|---|---|---|---|---|---|
| 0 | 0.95 | 1.11 | 1.55 | 2.25 | 3.00 |
| 1 | 0.93 | 1.08 | 1.55 | 2.25 | 3.00 |
| 2 | 0.91 | 1.05 | 1.55 | 2.25 | 3.00 |
| 3 | 0.89 | 1.02 | 1.50 | 2.20 | 3.00 |
| 4 | 0.87 | 0.99 | 1.50 | 2.20 | 3.00 |
| 5 | 0.85 | 0.96 | 1.50 | 2.20 | 3.00 |
| 6 | 0.83 | 0.94 | 1.45 | 2.15 | 3.00 |
| 7 | 0.82 | 0.92 | 1.45 | 2.15 | 3.00 |
| 8 | 0.81 | 0.90 | 1.45 | 2.15 | 3.00 |
| 9+ | 0.80 | 0.80 | 1.30 | 2.00 | 3.00 |

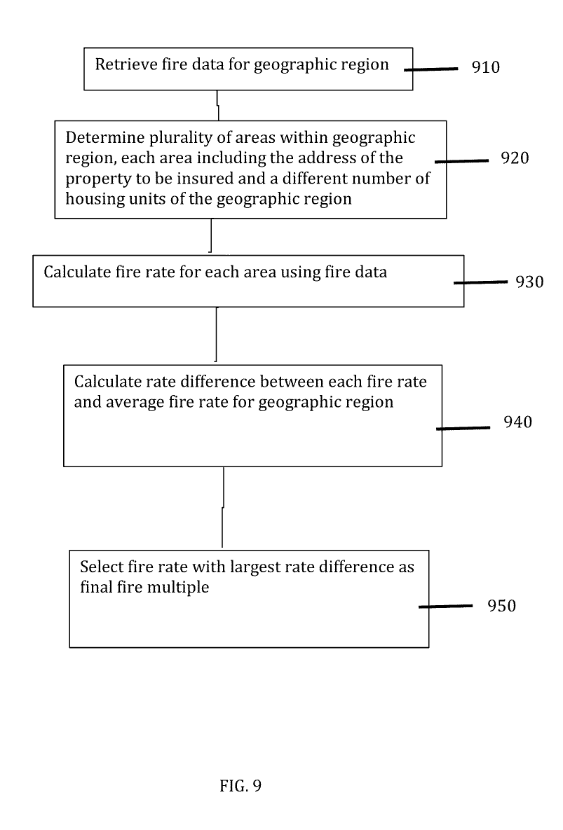

In some exemplary embodiments, the initial premium may be multiplied by a Fire factor multiple related to the fire rate in a neighborhood around current property. This is described in more detail below with reference to FIGS. 9-11.

In operation 750, the web server 510 generates a web page with the final insurance premium estimate and transmits the web page to the client device 550. The client device 550 receives the web page and displays final insurance premium estimate on the display 650 using a screen such as the coverage choice screen 200 shown in FIG. 2.

In some exemplary embodiments, the final insurance premium estimate may be transmitted to a smart home appliance, such as a smart smoke detector, or a smart circuit breaker. As discussed above, in some exemplary embodiments, the address-aware smart home appliance may send its own address to the web server 510. In this situation, in operation 750, the web server 510 may transmit the final insurance premium estimate to the address-aware smart home appliance. The address-aware smart home appliance may then display the final insurance premium estimate on a display of the address-aware smart home appliance, or may provide an audible indication of the final insurance premium estimate. That is, the address-aware smart home appliance may communicate with the homeowner either through a user interface of the address-aware smart home appliance (e.g. a smoke detector talking or displaying an indication of the estimate) or through an application (i.e., an app) associated with the address-aware smart home appliance that executes on a mobile phone, tablet, or phablet, etc. Additionally, the address-aware smart home appliance may also provide data about usage events of the smart home appliance to the web server 510, and the web server 510 may transmit a notification to the homeowner through the smart home appliance. For example, in the case of an address-aware smart smoke detector, the smart smoke detector may audibly output a message “based partially on your smoke detector data, you are eligible for homeowners insurance for $xxx/month”, or may transmit such a message to an application (i.e, an app) associated with the smart smoke detector. A system for implementing these exemplary embodiments is described in more detail below with reference to FIG. 12.

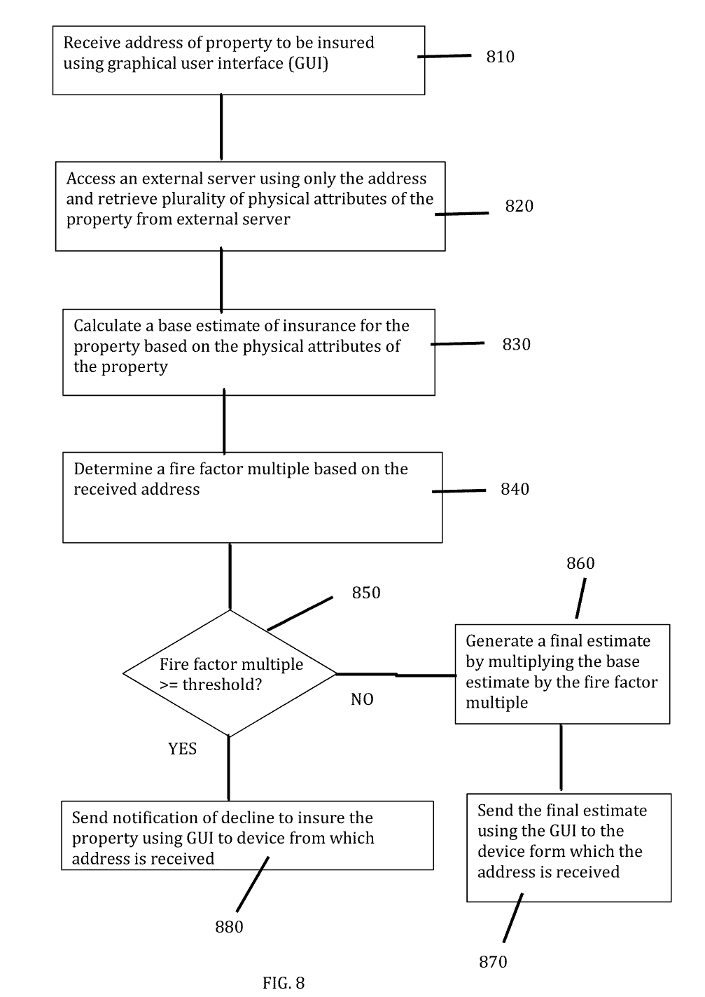

FIG. 8 is a flowchart showing a web-based homeowner's insurance premium estimate method according to another exemplary embodiment. The method of FIG. 8 will be explained in conjunction with FIGS. 1-6. The method of FIG. 8 is implemented by the web server 510.

The web server 510 receives an address of a property to be insured from a client device 550 using a graphical user interface (GUI) (810).

In operation 820, the web server 510 accesses the attribute server 530, and using only the address of the property to be insured that is entered by the user, retrieves a plurality of attributes of the property from the attribute server 530. Operations 810 and 820 are similar to operations 710 and 720, respectively, described above, and thus repeated description will not be provided.

In operation 830, the web server 510 calculates a base estimate of insurance for the property based on the retrieved attributes of the property.

In operation 840, the web server 510 determines a fire factor multiple based on the received address. The determination of the fire factor multiple will be described in further detail with reference to FIG. 9 below.

In operation 850, it is determined whether the fire factor multiple is greater than or equal to a threshold value. If the fire factor multiple is greater than the threshold (operation 850, YES), the web server 510 sends a notification of decline to insure the property at the address to be insured to the client device 550. When the fire factor multiple is greater than or equal to the threshold, the fire factor multiple is too high such that the risk is too great to insure the property. Thus, in this situation, the web server 510 will not provide a premium estimate to insure the property and the user is notified of this outcome.

On the other hand, if the fire factor multiple is less than the threshold (operation 850, NO), the web server 510 generates a final estimate by multiplying the base estimate by the fire factor multiple in operation 860. In operation 870, the final estimate is sent by the web server 510 to the device from which the address to be insured was received. For example, the web server 510 generates a web page with the final insurance premium estimate and sends the web page to the client device 550. The client device 550 receives the web page and displays final insurance premium estimate on the display 650 using a screen such as the coverage choice screen 200 shown in FIG. 2.

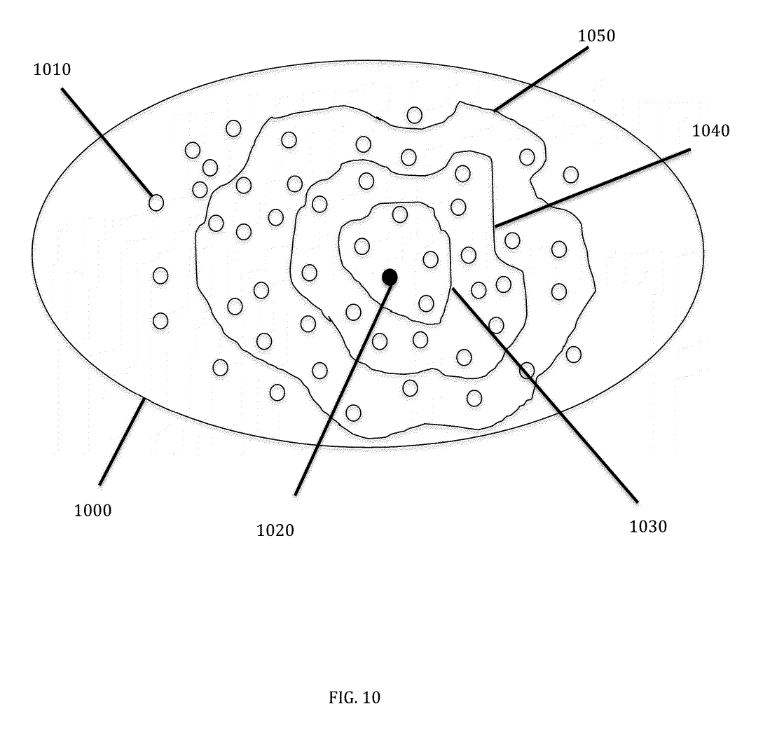

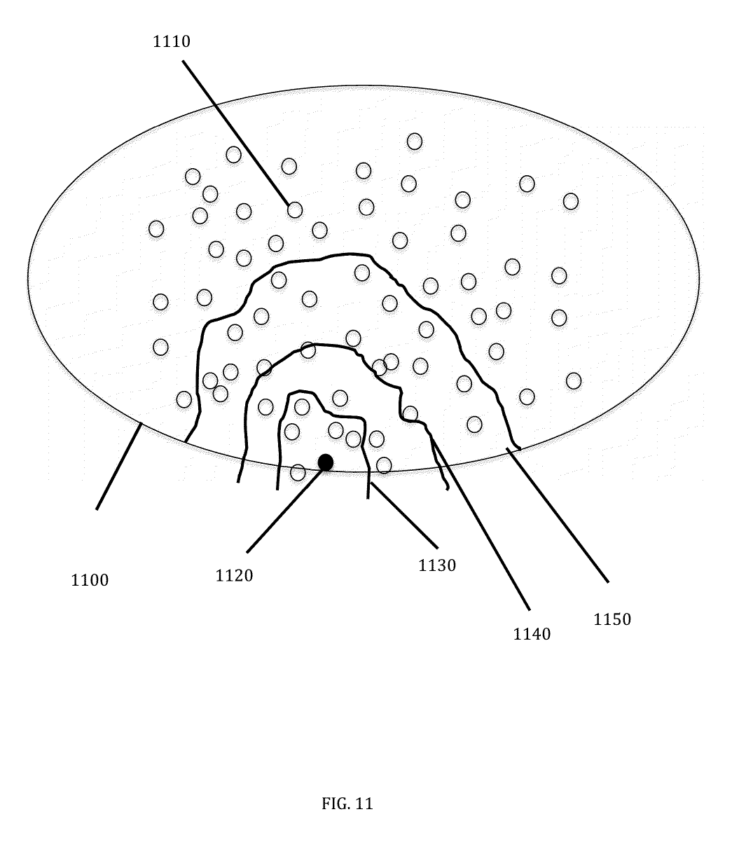

FIG. 9 is a flowchart showing an example of a method of determining a fire factor multiple according to an exemplary embodiment. FIGS. 10 and 11 are examples of areas within a geographic region according to an exemplary embodiment.

The method of FIG. 9 will be explained in conjunction with FIGS. 10-11. The method of FIG. 9 is implemented by the web server 510.

In operation 910, the web server 510 retrieves fire data for a geographic region including the address of the property to be insured. For example, the web server 510 may access the attribute server 530 in order to retrieve the fire data. Alternatively, the web server 510 may access an external server and/or database that includes the fire data for various geographic regions. FIGS. 10 and 11 each show an example of a geographic region. FIG. 10 shows a geographic region 1000, and FIG. 11 shows a geographic region 1100. The geographic region 1000 includes a plurality of housing units 1010, and the geographic region 1100 includes a plurality of housing units 1110.

In operation 920, the web server 510 determines a plurality of areas within the geographic region. Each of the areas includes the address of the property to be insured, and a different number of housing units of the geographic region. For example, a first area 1030, a second area 1040, and a third area 1040, each including the address of the property to be insured 1020 are shown in FIG. 10. Similarly, FIG. 11 shows a first area 1130, a second area 1140, and a third area 1150, each including the address of the property to be insured 1120. FIG. 10 shows an exemplary embodiment in which the first area 1030, the second area 1040, and the third area 1050 are roughly concentric around the address 1020. That is, the first area 1030 includes five (5) housing units. The second area 1040 includes eighteen (18) housing units, and the third area 1050 includes thirty-nine (39) housing units. However, this is only an example, and the areas may differ in both size and number of housing units depending on where in the geographic region the address to be insured is located. Thus, for example, FIG. 11 shows the first area 1130, the second area 1140, and the third area 1150 as horseshoe shaped areas, each area including the address to be insured 1120. In FIG. 11, the first area 1130, the second area 1140, and the third area 1150 have 6, 15, and 29 housing units, respectively. However, this is only an example, and one of ordinary skill in the art will understand that the number of housing units in a given geographic region, such as a metropolitan area, will include different numbers of housing units. Moreover, other arrangements of the areas are possible, as long as each of the areas includes the address of the property to be insured.

In operation 930, the web server 510 calculates a fire rate for each area using the fire data. In operation 940, the web server 510 calculates a rate difference between each fire rate and an average fire rate for the geographic region.

In operation 950, the web server 510 selects a fire rate with the largest rate difference as the final fire factor multiple.

Now will be described an actual example of calculating a fire factor multiple related to a fire rate in a neighborhood around a property at 1600 West Garfield Blvd, Chicago, Ill. 60609.

In this case, the geographic region is the Chicago metropolitan area. For the West Garfield Blvd. address, the plurality of different areas are determined according to minimum radii that include 2500, 5000, and 7500 housing units, respectively. One of ordinary skill will understand that the number of areas and the number of housing units in each area are examples, and may be different than three areas including 2500, 5000, and 7500 housing units, respectively. For each area, a number of fires within the area is determined, and a fire rate is then calculated for each area. Then the final estimate is chosen as the fire rate that is most significantly different than the average for a base rating territory, in this case the Chicago metropolitan area. For example, currently the average fire rate for Chicago is 3.3 fires per 1000 units.

Table 3 below shows the radii, distances, number of fires, fire rate (i.e., fires per 1000 units), and p-value for difference from territory average for 1600 West Garfield Blvd, Chicago, Ill. 60609.

TABLE 3

| | | | | p-value for |
|---|---|---|---|---|
| | | | | difference |
| | | Number of | Fires per 1000 | from territory |
| Area | Distance | Fires | Units | average |
| 2500 units | .67 km | 36 | 14.4 | 8.748407e−22 |
| 5000 units | 1.01 km | 80 | 16 | 1.768415e−55 |
| 7500 units | 1.28 km | 123 | 16.4 | 4.224514e−88 |

Although the fire rate estimates are similar and the p-values are highly significant, since the 7500-unit area is most significant, the final estimate of the fire factor multiple is chosen as a fire rate of 16.4 for this location, which is about 400% higher than average. As shown in operation 850 of FIG. 8, this final estimate fire factor multiple would be compared with a threshold value, and this would be a hard decline. For example, a typical threshold for a hard decline is any property over 70% higher than average.

A second example of a property at 100 Armitage Ave., Chicago, Ill. 60614 is shown below in Table 4.

TABLE 4

| | | | | p-value for |
|---|---|---|---|---|
| | | | | difference |
| | | Number of | Fires per 1000 | from territory |
| Area | Distance | Fires | Units | average |
| 2500 units | .46 km | 1 | 0.4 | 0.02 |
| 5000 units | .72 km | 4 | 0.8 | 0.003 |
| 7500 units | 1.00 km | 5 | 0.67 | 0.001 |

As shown in Table 4, since the 7500-unit area is most significant for this location also, a final fire factor multiple having a fire rate of 0.67 is chosen for this location, which is about ⅕th of the average.

The fire factor multiple allows for a streamlined user experience. The present inventors have discovered that the likelihood of fire varies so dramatically based on geographic location that this single factor predominates over the many smaller factors that related art systems use.

For example, the following data is typical of that gathered from homeowners by the related art to assess fire risk:
Year Built
Construction
Age and Type of wiring
Age and type of heating system
Number of type of fireplaces
Number of type of fire and smoke alarms
Number and ages of occupants
Relatedness of occupants.

While these data can be used to assess both the likelihood and severity of fires, individually and taken together they are less predictive of fire risk than what can be determined by looking at historical fire rates in a neighborhood around a specific property. For example, by analyzing a large database of fires, the inventors discovered that there is a large variance in fire rates in different neighborhoods of every metropolitan area in the country. For example, there are neighborhoods in Chicago where the number of fires per 1000 homes is 3000% higher than in other neighborhoods. In contrast, knowing the construction type of a building typically changes the estimated fire losses by 10%-25%. Accordingly, using the historical fire rates in a neighborhood around a specific property provides a more accurate assessment of fire risk of the property. It will be understood that Chicago is provided as an example, and the geographic area is not limited to any specific city, state or even country, as long as different areas each including the property address within a larger geographical region are provided.

In some exemplary embodiments, both the historical fire rates in a neighborhood around a specific property and data typically used by the related art may be combined to provide a premium estimate. When the historical fire rates in a neighborhood around a specific property are used in addition to the data typically used in the related art to assess fire risk, an even more complete peril picture may be provided. For example, the historical fire rates in a neighborhood around a specific property may be used to provide a coarse estimate, and the data discussed above as typically used by the related art to assess fire risk may be used to fine tune the coarse estimate.

In some exemplary embodiments, the final fire factor multiple may be modified using a factor related to the average fire severity of fires in the neighborhood of the current property. The fire severity factor is the ratio of the severity in the neighborhood around the property divided by the average fire severity in the larger geographic region used to determine the estimate of the base rate in operation 840.

In some exemplary embodiments, the final fire factor multiple may be modified using a factor related to the estimated fire department response time.

FIG. 12 is a system for providing an insurance premium estimate according to another exemplary embodiment. As shown in FIG. 12, the system 1200 includes a home network 1250, a network 1220, a web server 1210, an attribute server 1230, an attribute database 1235, an assessed value server 1240 and an assessed value database 1245. The network 1220, the web server 1210, the attribute server 1230, the attribute database 1235, the assessed value server 1240 and the assessed value database 1245 are similar to the network 520, the web server 510, the attribute server 530, the attribute database 535, the assessed value server 540 and the assessed value database 545 shown in FIG. 5, and therefore repeated description will be omitted.

The home network 1250 includes a client web browser 1260, a router 1270, a first smart appliance 1280, and a second smart appliance 1290. The client web browser 1260, the first smart appliance 1280 and the second smart appliance 1290 are each communicatively coupled to the router 1270 to form the home network 1250, and the home network 1250 is communicatively coupled to the network 1220 through the router 1270.

The first smart appliance 1280 may be a smoke/fire alarm that record data and the time of alarms in the property. The web server 1210 may access the first smart appliance 1280 in order to retrieve data from the smoke/fire alarm and use the data to generate a multiplier for modifying the base estimate.

The second smart appliance 1290 may be a smart circuit breaker that records a data and time of circuit overloads on the property. The web server 1210 may access the second smart appliance 1290 in order to retrieve data from the smart circuit breaker and use the data to generate a multiplier for modifying the base estimate.

The term “computer-readable storage medium” as used herein refers to any tangible medium, such as a disk or semiconductor memory, that participates in providing instructions to processor 614 for execution. For example, the computer-readable storage medium may be a removable disk readable by the removable storage device, or the memory 616, or a storage device located on a device on the network 690, each of which being accessible by the processor 614 of the computer server system.

Although the inventive concept has been described with reference to the above exemplary embodiments, it will be understood that modifications and variations are encompassed within the spirit and scope of the inventive concept. Accordingly, the inventive concept is limited only by the following claims.

What is claimed is:

1. A method comprising:
receiving an address of a property to be insured;
accessing an external attribute server and using only the address, retrieving a plurality of attributes of the property to be insured from the external attribute server;
calculating a premium estimate of insurance for the property to be insured based on the attributes of the property;
generating a final insurance premium estimate by multiplying the calculated estimate by at least one multiplier; and
transmitting the final insurance premium estimate to a device from which the address of the property to be insured was received.

2. The method of claim 1, wherein the plurality of attributes of the property comprise physical attributes of the property, including a construction type of the property and a square footage of the property.

3. The method of claim 1, wherein the plurality of attributes of the property comprise financial attributes of the property, including an assessed value.

4. The method of claim 1, further comprising accessing an external assessed value server and using only the address, retrieving an assessed value of the property to be insured, wherein the premium estimate of insurance is calculated based on the attributes of the property and the retrieved assessed value.

5. The method of claim 1, wherein the at least one multiplier comprises a limit of insurance factor, a previous claims factor, a fire factor, a fire severity factor and/or an estimated fire response time factor.

6. The method of claim 1, wherein the at least one multiplier is a fire factor, and wherein the fire factor is determined by:
accessing an external fire data server and retrieving a plurality of fire data for properties within a geographic region including the address, from the external fire data server;
determining a plurality of different areas within the geographic region, each area including the address and including a different number of housing units of the geographic region;
calculating a fire rate for each area using the retrieved fire data;
for each fire rate, calculating a rate difference between the fire rate and an average base fire rate for the geographic region, and selecting a fire rate having a largest rate difference as a fire factor multiple;
determining whether the selected fire factor multiple is less than a threshold value; and
when the selected fire factor multiple is less than the threshold value, generating the final insurance premium estimate by multiplying the premium estimate of insurance by the selected fire factor multiple.

7. The method of claim 1, wherein receiving the address of the property to be insured comprises:
sending a graphical user interface (GUI); and
receiving the address of the property to be insured from a user through the GUI.

8. The method of claim 1, wherein the address of the property to be insured is received from a system into which a user has previously entered and stored the address.

9. The method of claim 1, wherein receiving the address of the property to be insured comprises:
sending a graphical user interface (GUI);
receiving a code input by a user through the GUI, the code corresponding to one of a plurality of codes, each code being associated with a different address; and
retrieving the address of the property to be insured based on the received code.

10. The method of claim 1, wherein receiving the address of the property to be insured comprises:
receiving a photograph of an address to be insured; and
performing optical character recognition on the photograph in order to generate the address to be insured.

11. The method of claim 1, wherein receiving the address of the property to be insured comprises:
scanning a card encoded with the address to be insured, using a card reader in order to generate the address to be insured.

12. The method of claim 11, wherein the address to be insured is encoded in the card using a magnetic strip, a bar code, or a QR code, and the card reader reads the magnetic strip, the bar code, or the QR code.

13. The method of claim 1, further comprising confirming the address with a user by:
transmitting an address in a standardized format that corresponds to the received address; and
receiving a confirmation of the transmitted address from the user.

14. The method of claim 1, wherein the property comprises at least one smart home device, and the method further comprises:
remotely accessing the at least one smart home device to retrieve hazard data related to the property; and
modifying the base insurance premium estimate for the property based on the retrieved hazard data.

15. The method of claim 14, wherein the at least one smart home device comprises a smoke or fire alarm that records data for each actuation of the smoke or fire alarm, and wherein the retrieved hazard data is the recorded data.

16. The method of claim 14, wherein the at least one smart home device comprises a smart circuit breaker that records data for each occurrence of a circuit overload, and wherein the retrieved hazard data is the recorded data.

17. A method comprising:
receiving an address of a property to be insured;
accessing an external attribute server and using only the address, retrieving a plurality of attributes of the property to be insured;
calculating a base estimate of insurance for the property based on the attributes of the property;
determining a fire factor multiple based on the received address;
when the fire factor multiple is greater than or equal to a threshold value for a geographical region including the address, transmitting a notification of a decline to insure the property; and
when the fire factor multiple is less than the threshold value, generating a final estimate by multiplying the base estimate by the fire factor multiple, and transmitting the final estimate.

18. The method of claim 17, wherein the plurality of attributes of the property comprise physical attributes including a construction type of the property and a square footage of the property.

19. The method of claim 17, wherein the plurality of attributes of the property comprise financial attributes of the property, including an assessed value.

20. The method of claim 17, further comprising accessing an external assessed value server and using only the address, retrieving an assessed value of the property to be insured, wherein the base estimate of insurance is calculated based on the attributes of the property and the retrieved assessed value.

21. The method of claim 18, wherein the fire factor multiple is determined without consideration of the physical attributes of the property to be insured.

22. The method of claim 17, wherein the address of the property to be insured is received from a system into which a user has previously entered and stored the address.

23. The method of claim 17, wherein receiving the address of the property to be insured comprises:
transmitting a graphical user interface (GUI);
receiving a code input by a user through the GUI, the code corresponding to one of a plurality of codes, each code being associated with a different address; and
retrieving the address of the property to be insured based on the received code.

24. The method of claim 17, wherein receiving the address of the property to be insured comprises:
receiving a photograph of an address to be insured; and
performing optical character recognition on the photograph in order to generate the address to be insured.

25. The method of claim 17, wherein receiving the address of the property to be insured comprises:
scanning a card encoded with the address to be insured, using a card reader in order to generate the address to be insured.

26. The method of claim 25, wherein the address to be insured is encoded in the card using a magnetic strip, a bar code, or a QR code, and the card reader reads the magnetic strip, the bar code, or the QR code.

27. The method of claim 17, wherein the property comprises at least one smart home device, and the method further comprises:
remotely accessing the at least one smart home device to retrieve hazard data related to the property; and
modifying the base insurance premium estimate for the property based on the retrieved hazard data.

28. The method of claim 27, wherein the at least one smart home device comprises a smoke or fire alarm that records data for each actuation of the smoke or fire alarm, and wherein the retrieved hazard data is the recorded data.

29. The method of claim 27, wherein the at least one smart home device comprises a smart circuit breaker that records data for each occurrence of a circuit overload, and wherein the retrieved hazard data is the recorded data.

30. A method comprising:
receiving an address of a property to be insured;
accessing a first external server and using only the address, retrieving a plurality of physical attributes of the property to be insured;
accessing a second external server and using only the address, retrieving an assessed value for the property to be insured;
determining an estimated replacement cost for the property based on the retrieved assessed value and the retrieved physical attributes of the property;
calculating a base insurance premium estimate for the property based on the estimated replacement cost and a base rate;
accessing a third external server and retrieving a plurality of fire data for properties within a geographic region including the address, from the third external server;
determining a plurality of different areas within the geographic region, each area including the address and including a different number of housing units of the geographic region;
calculating a fire rate for each area using the retrieved fire data;
for each fire rate, calculating a rate difference between the fire rate and an average base fire rate for the geographic region, and selecting a fire rate having a largest rate difference as a fire factor multiple;
when the selected fire factor multiple is greater than or equal to a threshold value for the geographical region, transmitting a notification of a decline to insure the property; and
when the selected fire factor multiple is less than the threshold value, generating a final estimate by multiplying the base insurance premium estimate by the selected fire factor multiple, and transmitting the final estimate.

31. The method of claim 30, wherein receiving the address of the property to be insured comprises:
sending a graphical user interface (GUI); and
receiving the address of the property to be insured from a user through the GUI.

32. The method of claim 30, wherein the address of the property to be insured is received from a system into which a user has previously entered and stored the address.

33. The method of claim 30, wherein receiving the address of the property to be insured comprises:
sending a graphical user interface (GUI);
receiving a code input by a user through the GUI, the code corresponding to one of a plurality of codes, each code being associated with a different address; and
retrieving the address of the property to be insured based on the received code.

34. The method of claim 30, wherein receiving the address of the property to be insured comprises:
receiving a photograph of an address to be insured; and
performing optical character recognition on the photograph in order to generate the address to be insured.

35. The method of claim 30, wherein receiving the address of the property to be insured comprises:
scanning a card encoded with the address to be insured, using a card reader in order to generate the address to be insured.

36. The method of claim 35, wherein the address to be insured is encoded in the card using a magnetic strip, a bar code, or a QR code, and the card reader reads the magnetic strip, the bar code, or the QR code.

37. The method of claim 30, further comprising confirming the address with a user by:
transmitting an address in a standardized format that corresponds to the received address; and
receiving a confirmation of the transmitted address from the user.

38. The method of claim 30, wherein the property comprises at least one smart home device, and the method further comprises:
remotely accessing the at least one smart home device to retrieve hazard data related to the property; and
modifying the base insurance premium estimate for the property based on the retrieved hazard data.

39. The method of claim 38, wherein the at least one smart home device comprises a smoke or fire alarm that records data for each actuation of the smoke or fire alarm, and wherein the retrieved hazard data is the recorded data.

40. The method of claim 38, wherein the at least one smart home device comprises a smart circuit breaker that records data for each occurrence of a circuit overload, and wherein the retrieved hazard data is the recorded data.

41. The method of claim 1, wherein the address of the property to be insured is received from an address-aware smart appliance, and the device to which the final insurance premium estimate is transmitted is the address-aware smart appliance.

42. The method of claim 17, wherein the address of the property to be insured is received from an address-aware smart appliance, and the final estimate is transmitted to the address-aware smart appliance from which the address was received.

43. The method of claim 30, wherein the address of the property to be insured is received from an address-aware smart appliance, and the final estimate is transmitted to the address-aware smart appliance from which the address was received.
